(19) United States
(12) Patent Application Publication
(10) Pub. No.: US 2003/0077022 A1
(43) Pub. Date: Apr. 24, 2003

(54) Complex optical switch arrays

(76) Inventors: Kai Y. Eng, Atlantic Highlands, NJ (US); Jon Anderson, Brielle, NJ (US)

Correspondence Address: KAPLAN & GILMAN , L.L.P., 900NROUTE 9 NORTH, WOODBRIDGE, NJ, 07095, US

(21) Appl. No.: 10/000,731

(22) Filed: Oct. 24, 2001

(51) Int. Cl. G02B 6/35; G02B 6/28

(52) U.S. Cl. 385/16; 385/24

(57) ABSTRACT

The present invention provides switch arrays for use in optical communication systems. The switch arrays are illustrated in relatively simple and relatively complex versions for each of two types. Each switch array is assembled by connecting of plural optical switches to each other and to transmission links and packet switches accordingly. The result enables handling a greater quantity of signal volume.

### FIELD OF THE INVENTION

The present invention relates to the field of optical communication signal switching, and more particularly to arrangements for an array of switches to create a complex switch.

### BACKGROUND OF THE INVENTION

Optical communication signals rely on laser light beams to transmit data. Laser beams are considered to be coherent, or linear, light. As such, they do not tend to diffuse to the same degree as ordinary light. Ordinary light will diffuse to the extent that its power per unit area will diminish in proportion to the square of the distance over which it travels.

Modern optical communication consists of digitized signals that comprise a message or data portion and an identifying portion. The identifying portion, often referred to as a header, provides information for assembling a number of message components into a complete message as well as the intended destination of the message, e.g. an email address. When a communication controller such as a computer receives and analyzes a message header, the controller routes the message to direct it to the intended destination. This routing involves causing the message to be switched at various junctions from an incoming transmission cable to a different outgoing transmission cable.

Optical switches are known in rudimentary forms, such as 4×4, 8×8, or 16×16 ports. This nomenclature indicates that, in the first example, four input cables and four output cables are connected to a switch to allow signals to be routed straight through or diverted in direction to a different route. However, as communication by optical signal grows, greater complexities of switches are needed to handle the volume. It has yet been impractical to build a single 32×32 port or larger switch because of difficulties in maintaining the direction of an optical signal with sufficient accuracy to maintain its power and transmitted data in tact.

Therefore, it is an object of the present invention to provide an optical switch array that conveys and routes a large number of optical messages.

This and other objects will become more apparent from the description of the invention to follow.

### SUMMARY OF THE INVENTION

The present invention provides arrays of optical switches connected so as to control the movement of messages in a communication system. Micro electro mechanical system (MEMS) switches or Optical Switch Modules (OSMs) are connected in an array to grow capacity and retain flexibility. Messages are transmitted, added to or deleted from through optical switch manipulation.

### BRIEF DESCRIPTION OF THE DRAWINGS

FIG. 1 is a schematic diagram of a 32×32 optical switch array utilizing 16×16 switch components.

FIG. 2 is a schematic diagram of a 64×64 optical switch array utilizing 16×16 switch components.

FIG. 3 is a schematic diagram of an 8×8 optical switch array.

FIG. 4 is a schematic diagram of a 32×32 optical switch array utilizing 8×8 switch components.

### DETAILED DESCRIPTION OF THE INVENTION

The present invention provides an optical switch array by description of the following exemplary group of switch arrays. The switch array of the invention utilizes multiple switch components each having a small number of optical ports in a combination enabling an expanded number of ports in the array. Messages or signals are typically transmitted as a plurality of TCP packets that each comprise a data portion and an identifying header. When an optical signal packet arrives at a switch point in an optical circuit, the packet header is parsed for information regarding its intended destination so as to be routed accordingly. Instructions are generated according to the intended destination and the available line capacities.

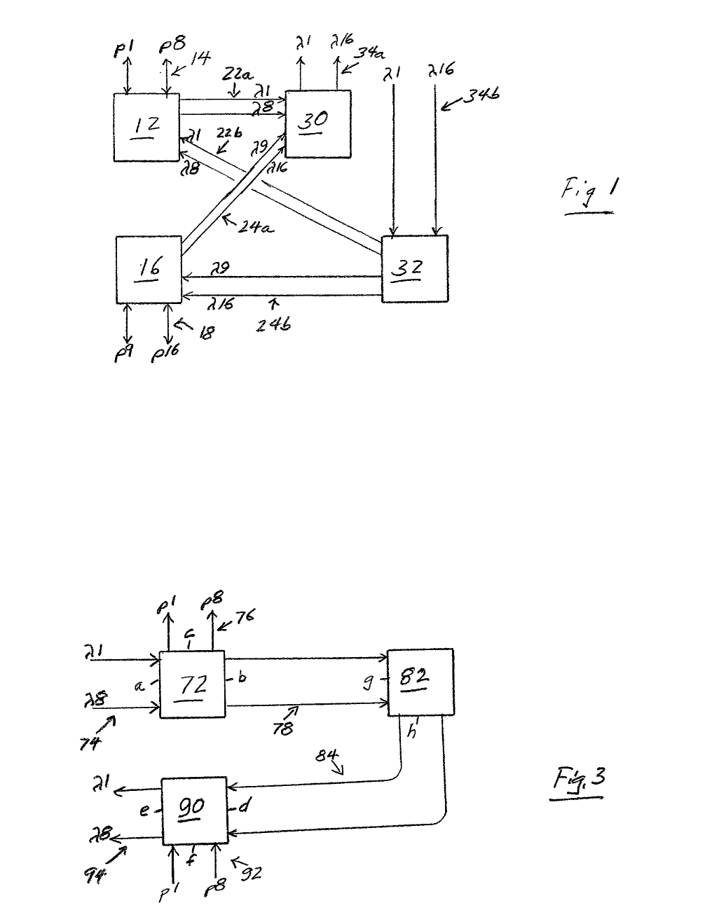

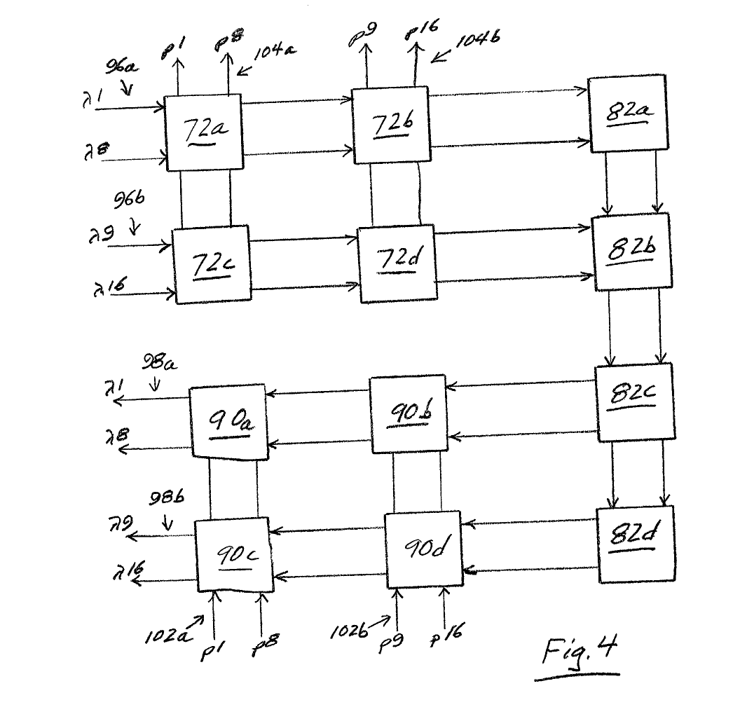

As illustrated in FIG. 1, a switch array includes optical switch module (OSM) 12 and OSM 16. Each of OSM 12 and OSM 16 is an assembly of switch components as shown in FIG. 3, described below. OSM 12 and OSM 16 are each two-plane 16×16 switch modules, that is they are each capable of receiving and transmitting 16 optical signals through two planes, or sets of connective ports. OSM 12 receives and transmits optical signals 14, noted as p1 through p8 and OSM 16 receives and transmits optical signals 18, noted as p9 through p16. By indicating eight ports of both receiving and transmitting, each module has a total of 16 ports for adding and dropping, i.e. receiving signals from or sending signals to networks and terminal devices. Add/drop ports p1 through p16 are connected to local packet switches to add signals to or drop signals from the optical transmission circuit, such signals typically being handled in packets under TCP/IP procedures, as is known. Each of OSM 12 and 16 is capable of connecting any input signal to any output port at the same or a different wavelength as the wavelength received. The diversion of signal routing is accomplished within the OSMs according to instructions generated by a controller (not shown). Thus, 16×16 OSM 30 and 16×16 OSM 32 provide a 32×32 OSM assembly (32 ports in and 32 ports out) when optically connected as illustrated. OSM 30 and OSM 32 are shown as four-plane modules for possible array expansion, but only two planes of each are connected herein. OSM 32 receives input signals 34b from a communication network connected by optical fiber as a multiplexed transmission of multiple wavelengths λ1-λ16. The optical switches include apparatus to multiplex and demultiplex signals. OSM 32 directs selected ones of the signals to OSM 12 via transmission link 22b and others to OSM 16 via transmission link 24b. OSM 12 and OSM 16 each route the received signals either to drop lines 14 or 18 or to OSM 30 through transmission link 22a or transmission link 24a. Packets received into OSM 30 are diverted to appropriate ports and sent onward via output signals 34a. As it is illustrated, array 10 is formed as an assembly of three optical switches connected in series with each other. The transmitting wavelengths may be the same as or different than the receiving wavelengths.

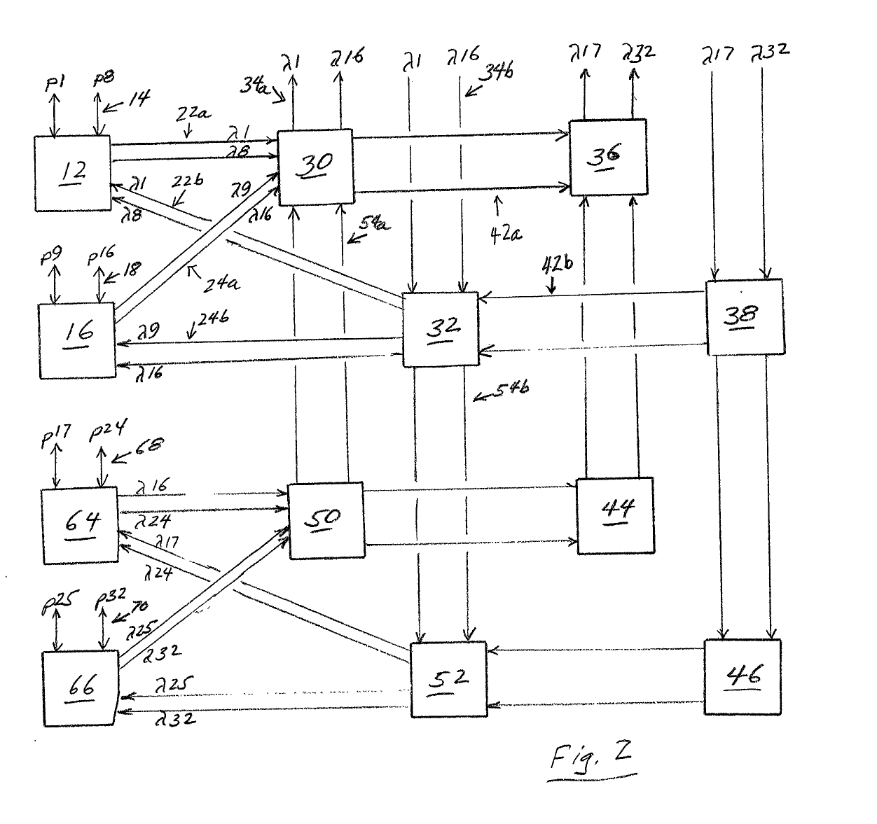

Since the fundamental object of the present invention is to achieve increased optical signal processing capacity in a modular system, FIG. 2 provides a switch array that utilizes the principles of FIG. 1 above in greater size and capacity. It will be apparent to those skilled in the art that the upper left hand quadrant of FIG. 2 (components 12, 16, 30, 32) is substantially equivalent to the switch array illustrated in FIG. 1. In the FIG. 2 expanded array, each of four plane 16×16 OSMs 30 and 32 are connected on all four sides, utilizing their full capacities. OSM 30 is thus, in addition to transmission link 22a from OSM 12 and transmission link 24a, connected to OSM 36 by transmission link 42a and to OSM 50 by transmission link 54a. Similarly, OSM 32 is connected to OSM 38 by transmission link 42b and to OSM 52 by transmission link 54b.

In the assembled switch array of FIG. 2 a first OSM loop is formed by OSM 30 connected to OSM 36 connected to OSM 44 connected to OSM 50 as a drop signal sorting circuit. A second OSM loop is formed by OSM 32 connected to OSM 38 connected to OSM 46 connected to OSM 52 as an add signal sorting circuit. In this arrangement, while OSM 30 and OSM 32 are presented as four plane, OSM 44 and OSM 46 have two planes each and OSMs 36, 38, 50 and 52 each have three planes. The functions of each of the OSM units is similar to that described in respect to FIG. 1 above. In addition to the add/drop terminals 14 and 18 of optical switches 12 and 16, respectively, add/drop terminals 68 and 70 emanate from OSMs 64 and 66, respectively.

Referring now to FIG. 3, an optical switch module as a relay junction for controlling and directing optical signals is illustrated. The illustrated optical switch module is comprised, in its simplest form, of a first 8×8 three-plane micro electronic mechanical system (MEMS) switch 72 and a second three-plane MEMS switch 90 that are connected respectively to the input and output of an 8×8 two-plane MEMS switch 82. A two-plane MEMS, such as MEMS 82, receives an optical signal at one of its plural input ports on input plane g and routes the signal to a selected output port on output plane h, according to output port availability. A three-plane MEMS, such as MEMS 72, receives an optical signal at one of its plural input ports on input plane a and routes the signal to a selected drop port on plane c, or passes the signal through to a corresponding output port on output plane b, as indicated in the packet header information. A four-plane MEMS, for example MEMS 30 of FIG. 2 and MEMS 72 of FIG. 4, performs similarly to three-plane MEMS, with two planes of input ports and two planes of output ports. First 8×8 MEMS switch 72 receives two sets of transmitted communication input signals at wavelengths λ1-λ8, noted as signals 74. MEMS switch 72 is controlled so as to direct a selected input signal 74 to either of transmission output 78 that serves as input to MEMS switch 82 or drop lines 76 P-1 through P-8. Drop lines 76 P-1 through P-8 are connected externally to packet switches for transmitting signals to a recipient client application (not shown). MEMS switch 82 operates to transmit signals 78 via signals 84 to MEMS switch 90, and has the capability of altering the transmission channel allocation and the signal wavelength at the same time in order to allocate available output channels from MEMS switch 90. MEMS switch 90 is connected to receive add lines 92 signals P-1 through P-8 from system external packet switches (not shown). The net signals of input signals 74 minus dropped signals 76 plus added signals 92 is transmitted output signals 94, shown in wavelengths λ1-λ8 to a further relay module.

In keeping with the principle of growability of the present invention, a switch array is illustrated in FIG. 4 that provides an expanded version of the switch array shown in FIG. 3. Input transmission signals 96a and 96b, each being in sets of wavelengths λ1-8 and λ9-16, respectively, are fed to MEMS switch 72a and MEMS switch 72c, which are each connected to MEMS switch 72b and 72d, respectively. It is readily seen that MEMS switches 72a-72b-72c-72d are operable as a three plane unit having sixteen ports on each plane. This MEMS switch unit is connected to MEMS switches 82a and 82b which then connect to MEMS switches 82c and 82d, forming an equivalent of a two plane MEMS switch with increased capacity. MEMS switches 82c and 82d transmit to MEMS switches 90b and 90d which transmit to MEMS switches 90a and 90c respectively. Therefore, the complex switch array of FIG. 4 represents a larger capacity version of the switch array of FIG. 3. Output signals 98a and 98b transmit signals out from MEMS switch unit 90a-90b-90c-90d with signal wavelengths λ1-λ16. In addition to input signals 96a, 96b and output signals 98a, 98b, add signals 102a, 102b are connected to switches 90c and 90d, and drop signals 104a, 104b are connected to transmit signals from switches 72a and 72b. Thus, while the switch array of FIG. 4 assembles 8×8 MEMS switches to result in a 32×32 array, increase of the module size to 16×16 would therefore result in a 64×64 array.

While the present invention is described with respect to specific embodiments thereof, it is recognized that various modifications and variations may be made without departing from the scope and spirit of the invention, which is more clearly and precisely defined by reference to the claims appended hereto.

What is claimed is:

1. An optical switch array comprising:
(a) a first optical switch connected for receiving signals from a source;
(b) a second optical switch connected for receiving at least a portion of the signals from the first optical switch;
(c) a third optical switch connected for receiving the portion of the signals from the second optical switch and adapted for transmitting signals therefrom; and
(d) wherein at least one of the optical switches is connected for receiving incoming signals from a first packet switch and one of the optical switches is connected for transmitting outgoing signals to a second packet switch.

2. The optical switch array as described in claim 1, wherein the first optical switch and the second optical switch are connected for receiving signals from and transmitting signals to the first and second packet switches.

3. The optical switch array as described in claim 1, further comprising a fourth optical switch connected so as to receive a remainder of signals from the first optical switch and to transmit the remainder of signals to the third optical switch.

4. The optical switch array as described in claim 3, wherein the second optical switch and the fourth optical switch are connected for receiving signals from and transmitting signals to the first and second packet switches.

5. The optical switch array as described in claim 1 wherein one of the first, second or third optical switches is able to reconfigure a signal from a first incoming wavelength to a second outgoing wavelength that is different than the first incoming wavelength.

6. The optical switch array as described in claim 1 wherein one of the first, second or third optical switches is able to reroute a signal from a first incoming port to a second outgoing port that is in a different position than the first incoming port.

7. A complex optical switch array, comprising:
(a) a first optical switch for receiving and transmitting optical signals;
(b) a second optical switch connected for receiving signals from the first optical switch;
(c) a third optical switch connected for receiving signals from the second optical switch and transmitting the received signals;
(d) the third optical switch is additionally connected for adding new input signals from a source; and
(e) the first optical switch is additionally connected for dropping certain signals.

8. The complex optical switch array as described in claim 7, wherein the second optical switch is capable of receiving signals at a first wavelength and transmitting the received signals at a second wavelength.

9. The complex optical switch array as described in claim 7, wherein the second optical switch is capable of receiving signals at a first port location and transmitting the received signals at a second port location.

10. A switching apparatus comprising a first switch having input ports and output ports, a second switch having input ports and output ports and add drop ports, and a third switch having input ports and output ports and add drop ports, the add drop ports of said second and third switches being connected to packet switches, the input ports of said first switch being connected to the output ports of said second switch, the output ports of said first switch being connected to the input ports of said third switch, the first switch being an optical switch arranged to translate inputs on one or more first wavelengths to outputs on one or more different wavelengths.

11. The switching apparatus of claim 1 wherein said first switch has less sets of ports than said second switch or said third switch.

12. The optical switching array as claimed in claim 10, wherein at least one of the optical switches is further connected to a packet switch in a packet switched network.
